(19) United States
(12) Patent Application Publication
(10) Pub. No.: US 2002/0196255 A1
(43) Pub. Date: Dec. 26, 2002

(54) Image drawing system and image drawing method

(75) Inventor: Takahiro Saito, Yokohama-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/175,800

(22) Filed: Jun. 21, 2002

(30) Foreign Application Priority Data
Jun. 22, 2001 (JP) 2001-189926

(51) Int. Cl. G06T 11/20

(52) U.S. Cl. 345/440

(57) ABSTRACT

An image drawing apparatus, comprising: a coordinate storing part which stores coordinate locations of drawing points in which at least one of a depth value designating depth information of the drawing points and a stencil value designating mask information of the drawing point may be updated; a precedent drawing determination part which performs at least one of a first drawing determination part configured to determine whether or not to perform drawing based the depth value stored in the coordinate storing part and a second drawing determination part configured to determine whether or not to perform drawing based the stencil value, for each coordinate location; a drawing part which decides a color for each drawing point to perform drawing processing, and omits the drawing processing with regard to the coordinate location determined not to perform the drawing by the precedent drawing determination part.

### CROSS REFERENCE TO RELATED APPLICATIONS

This application is based upon and claims the benefit of priority from the prior Japanese Patent Applications No. 2001-189926, filed on Jun. 22, 2001, the entire contents of which are incorporated herein by reference.

### BACKGROUND OF THE INVENTION

1. Field of the Invention

The present invention relates to an image drawing system for performing drawing determination processings based on a depth and a stencil value, as to whether to draw 3D objects.

2. Related Background Art

When drawing 3D objects, as a method of determining whether or not to draw positions of the inputted coordinates, a drawing determination processing (a depth test) based on a depth value designating depth information of drawing points, a drawing determination processing (a stencil test) based on a stencil value designating mask information of drawing points, and a drawing determination processing (an alpha test) based on an alpha value. Because it is impossible to perform the drawing determination processing based on the alpha value as long as a definite color is not determined, it is general that these determination processings are performed just before the drawing data is stored in the drawing memory, that is, after the definite color is determined.

Recently, as an operation for determining the color, however, a multi-texture which determines the color by overlapping a plurality of drawings is well used. Because the multi-texture performs a complicated calculation with regard to the coordinates not to be drawn, the calculation result actually appears to be wasted. Especially, in the case of performing the drawing by overlapping a plurality of drawings, the number of the drawing data to perform the drawing determination processing such as the depth value increases. Because of this, it takes too much time to perform the drawing processing.

### SUMMARY OF THE INVENTION

An image drawing apparatus according to an embodiment of the present invention, comprising:

a coordinate storing part which stores coordinate locations of drawing points in which at least one of a depth value designating depth information of the drawing points and a stencil value designating mask information of the drawing point may be updated;

a precedent drawing determination part which performs at least one of a first drawing determination part configured to determine whether or not to perform drawing based the depth value stored in said coordinate storing part and a second drawing determination part configured to determine whether or not to perform drawing based the stencil value, for each coordinate location;

a drawing part which decides a color for each drawing point to perform drawing processing, and omits the drawing processing with regard to the coordinate location determined not to perform the drawing by said precedent drawing determination part.

Furthermore, an image drawing apparatus according to an embodiment of the present invention, comprising:

a coordinate storing part which stores coordinate locations of drawing points in which at least one of a depth value designating depth information of the drawing points and a stencil value designating mask information of the drawing point may be updated;

a first drawing determination part which determines whether or not to perform drawing based on the depth value for each coordinate location stored in said coordinate storing part;

a second drawing determination part which determines whether or not to perform drawing based on the stencil value for each coordinate location stored in said coordinate storing part; and

a drawing part which decides a color for each drawing point to perform drawing processing with regard to the coordinate location determined to perform the drawing by said first and second drawing determination parts, and omits said drawing processing with regard to the coordinate location determined not to perform the drawing by at least one of said first and second drawing determination parts.

Furthermore, an image drawing apparatus according to an embodiment of the present invention, comprising:

a coordinate storing part which stores coordinate locations of drawing points in which at least one of a depth value designating depth information of the drawing points and a stencil value designating mask information of the drawing points may be updated;

a first drawing determination part which determines whether or not to perform drawing based on the depth value stored in said coordinate storing part for each coordinate location stored in said coordinate storing part;

a second drawing determination part which determines whether or not to perform drawing based on the stencil value for each coordinate location stored in said coordinate storing part;

a third drawing determination part which determines whether or not to perform drawing based on an alpha value designating degree of transparency of the drawing points; and

a drawing part which if determined to perform the drawing by said third drawing determination part, after performing the processings by said first and second drawing determination parts, decides a color for each drawing point to perform drawing processing, and omits the drawing processing with regard to the coordinate location determined not to perform the drawing by said third drawing determination part.

### BRIEF DESCRIPTION OF THE DRAWINGS

FIG. 1 is a block diagram showing schematic configuration of a first embodiment of an image drawing apparatus according to the present invention.

FIG. 2 is a flowchart showing processing procedure of the image drawing apparatus of FIG. 1.

FIG. 3 is a block diagram of a second embodiment of an image drawing apparatus according to the present invention.

FIG. 4 is a flowchart showing processing procedure of the image drawing apparatus of FIG. 3.

FIG. 5 is a block diagram of a third embodiment of an image drawing apparatus according to the present invention.

FIG. 6 is a flowchart showing processing procedure of the image drawing system of FIG. 5.

FIG. 7 is a block diagram in the case of adding the drawing order exchanging part to the configurations of FIG. 3.

### DESCRIPTION OF THE PREFERRED EMBODIMENTS

Hereinafter, an image drawing apparatus according to the present invention will be more specifically described with reference to drawings.

### FIRST EMBODIMENT

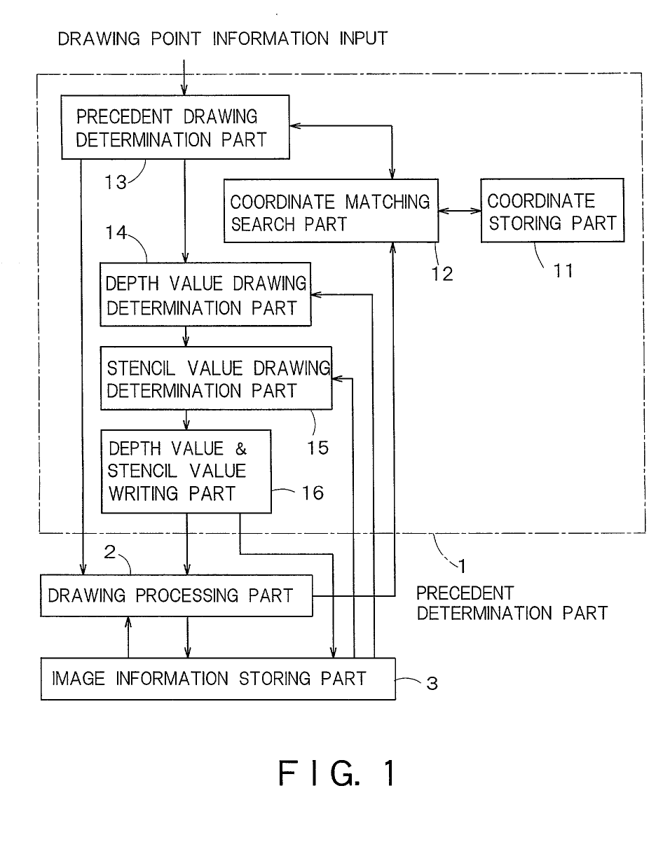

FIG. 1 is a block diagram showing schematic configuration of a first embodiment of an image drawing apparatus according to the present invention. The image drawing apparatus of FIG. 1 has a precedent determination part 1, a drawing processing part 2 for performing ordinary drawing processing, and an image information storing part 3 for storing drawing data after drawing processing.

The precedent determination part 1 has a coordinate storing part 11 for storing the inputted coordinate location, a coordinate matching search part 12 for searching whether or not the inputted coordinate location coincides with the coordinate location temporarily stored in the coordinate storing part 11, a precedent drawing determination part 13 for determining whether or not the drawing determination processings based on the depth value or the stencil value are performed preceding the drawing processings, a depth value drawing determination part 14 for performing the drawing determination processing based on the depth value preceding the drawing processing, a stencil value drawing determination part 15 for performing the drawing determination processing based on the stencil value preceding the drawing processing, a depth value & stencil value writing part 16 for writing the depth value and the stencil value.

Here, a drawing determination processing based on the depth value (the depth test) compares the depth value of the inputted coordinate location with the depth value of the coordinate location stored in the image information storing part 3, and determines whether or not to draw the inputted coordinate location. When passed to the determination processing, the drawing processing is not performed. The depth value is a value designating the depth information of the drawing point, and it becomes small as the drawing point locates near side.

The drawing determination processing based on the stencil value (the stencil test) determines whether or not to perform the drawing based on the stencil value designating mask information of the drawing point, and when passed to the determination processing, the drawing processing is not performed.

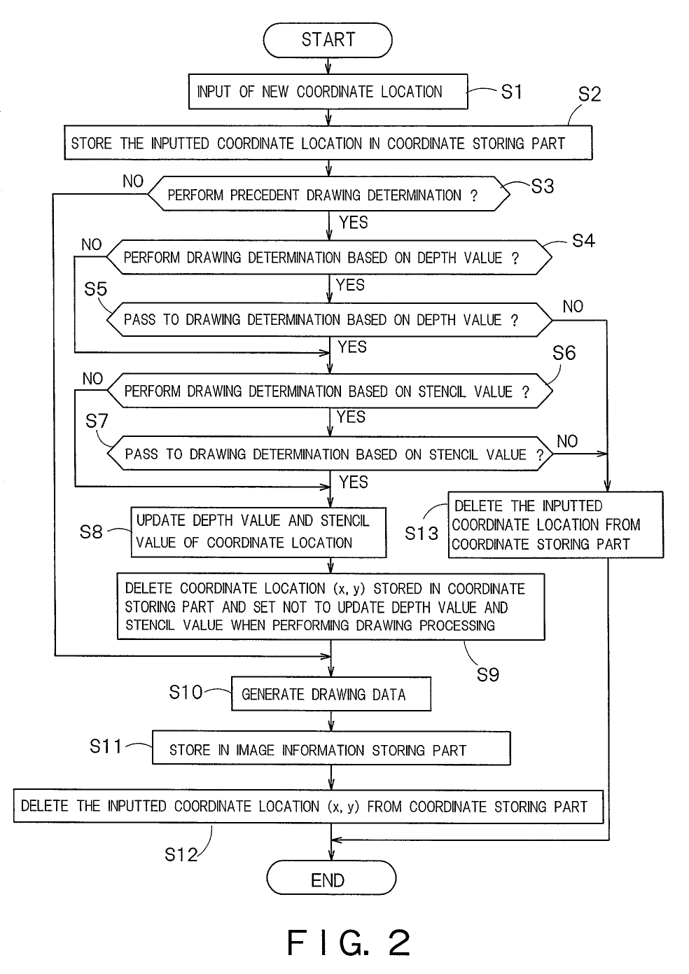

FIG. 2 is a flowchart showing processing procedure of the image drawing apparatus of FIG. 1. First of all, new coordinate location is inputted (step S1). If the inputted coordinate location is set to write the depth value or the stencil value, the coordinate location (x, y) is stored in the coordinate storing part 11 (step S2). If the same coordinate location (x, y) is already stored in the coordinate storing part, the number of times that the coordinate location (x, y) is inputted is stored in the coordinate storing part 11.

Subsequently, it is determined whether or not to perform the precedent drawing determination (step S3). Here, when the inputted coordinate location (x, y) is not stored in the coordinate storing part 11, and the drawing determination processing based on the after-mentioned alpha value is not performed, it is determined to perform the precedent drawing determination.

When determined that the precedent drawing determination is performed, it is determined whether or not to perform the drawing determination processing (depth test) based on the depth value (step S4). When determined that the drawing determination processing is performed, the processing is performed, and then it is determined whether or not to pass to the processing (step S5). The case of passing to step S5 is, for example, the case where the coordinate location inputted in step S1 locates nearer side.

When determined to pass to the drawing determination processing based on the depth value, it is determined whether or not to perform the drawing determination processing (stencil test) based on the stencil value with regard to the coordinate location inputted in step S1 (step S6). The case of passing to the processing of step S6 is, for example, the case where the coordinate location inputted in step S1 is not masked.

When determined to perform the drawing determination processing based on the stencil value, the drawing determination processing is performed, and it is determined whether or not to pass to the drawing determination processing (step S7).

When passing to the drawing determination processing based on the stencil value, after the depth value and the stencil value of the coordinate location inputted in step S1 are updated (step S8), the coordinate location (x, y) temporarily stored in the coordinate storing part 11 is deleted, and it is set not to perform the update processing of the depth value and the stencil value in the after-mentioned drawing processing (step S9).

When determined not to perform the precedent drawing determination in step S3, or the processing of step S9 is finished, the drawing processing part 2 performs the drawing processing to generate the drawing data by deciding the color of the coordinate location inputted in step S1 (step S10), and stores the data in the image information storing part 3 (step S11).

After the processing of step S10 is finished, the coordinate location (x, y) inputted in step S1 is deleted from the coordinate storing part 11 (step S12).

On the other hand, when not being passed to the drawing determination processing based on the depth value in step S5, or when not being passed to the drawing determination processing based on the stencil value in step S7, the coordinate location inputted in step S1 is deleted from the coordinate storing part 11 (step S13).

When the same coordinate location as that stored in the coordinate storing part 11 are inputted, instead of performing the processing of FIG. 2, the update processings of the depth value and the stencil value are performed in the drawing processing part 2.

Thus, the present embodiment performs the drawing determination processing based on the depth value and the drawing determination processing based on the stencil value are performed before the drawing processing by the drawing processing part 2, and does not perform the drawing processing with regard to the coordinate location not passed to these determination processings. Because of this, there is no likelihood to perform the drawing processing in vain with regard to the coordinate location not drawn in actuality, thereby speeding up the drawing processing. That is, conventionally, when performing the multi-texture processing, complicated calculation was performed with regard to the points not drawn in actuality. However, according to the present invention, the precedent drawing determination is performed before the drawing processing, and the drawing processing is performed with regard to only the coordinate locations passed to the determination result. Because of this, it is possible to perform the drawing processing in no vain at high speed.

### SECOND EMBODIMENT

A second embodiment changes the processing procedure by whether or not drawing determination based on an alpha value is performed.

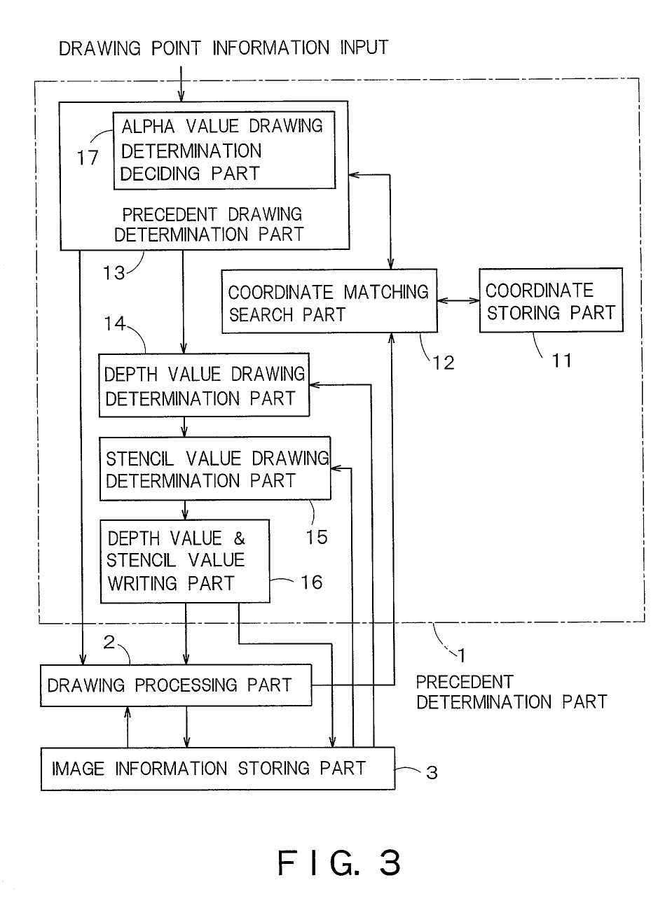

FIG. 3 is a block diagram of a second embodiment of an image drawing apparatus according to the present invention. In FIG. 3, the same figure number is attached to constituents common to FIG. 1. Hereinafter, different points will be mainly described.

The image drawing apparatus of FIG. 3 has an alpha value drawing determination deciding part 17 for deciding whether or not to perform a drawing determination processing (alpha test) based on the alpha value designating degree of transparency of drawing points. The alpha value drawing determination deciding part 17 is provided in the precedent drawing determination part 13.

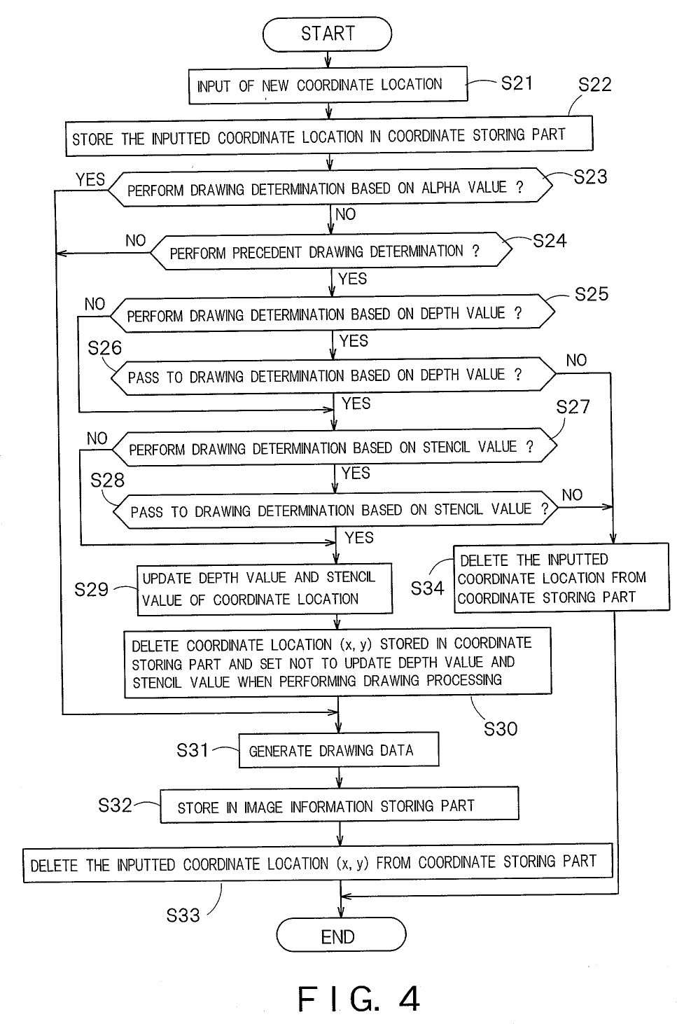

FIG. 4 is a flowchart showing processing procedure of the image drawing apparatus of FIG. 3. After the new coordinate location (x,y) is inputted (step S21), if the coordinate location is set to store the depth value or the stencil value, the coordinate location (x, y) is stored in the coordinate storing part 11 (step S22).

Subsequently, it is determined whether or not to perform the drawing determination processing based on the alpha value (step S23). When the drawing determination processing is not performed based on the alpha value, the same processings as those of steps S3-S13 of FIG. 2 are performed (step S24-S33). When the drawing detemination processing is performed based on the alpha value, the drawing determination processing based on the alpha value, the drawing determination processing based on the depth value and the drawing determination processing based on the stencil value are performed in the drawing processing part 2. That is, when the drawing determination processing based on the alpha value is performed, the precedent drawing determination is not performed. The reason is because it is impossible to perform the drawing determination processing based on the alpha value as long as the color of the drawing point is not decided, and it is impossible to update the depth value and the stencil value without receiving the result of the drawing determination processing based on the alpha value.

On the other hand, when the drawing determination processing based on the alpha value is not performed, before the drawing processing based on the drawing processing part 2 is performed, the drawing determination processing based on the depth value and the drawing determination processing based on the stencil value are performed. Only when passed to both of the determination processings, the drawing processing is performed.

Thus, the second embodiment determines whether or not to perform the drawing determination processing based on the alpha value. When the drawing determination processing based on the alpha value is performed, after the drawing determination processing based on the alpha value is performed, the depth value and the stencil value are updated. Because of this, it is possible to avoid the occurrence of the problem in which the depth value of the transparent point is erroneously updated. That is, if the depth value of the coordinate location determined to be transparent is erroneously updated by the drawing determination processing based on the alpha value, there is a likelihood in which the point to be transparent is not transparent. In the case of the present embodiment, however, the depth value of the coordinate locations determined not to perform drawing by the drawing determination processing based on the alpha value is not updated. Because of this, it is possible to surely avoid the problem such that the point to be transparent is not transparent.

### THIRD EMBODIMENT

A third embodiment does not perform the drawing processing until the processing of the point inputted precedently is finished, when the newly inputted coordinate location is already stored in the coordinate storing part 11.

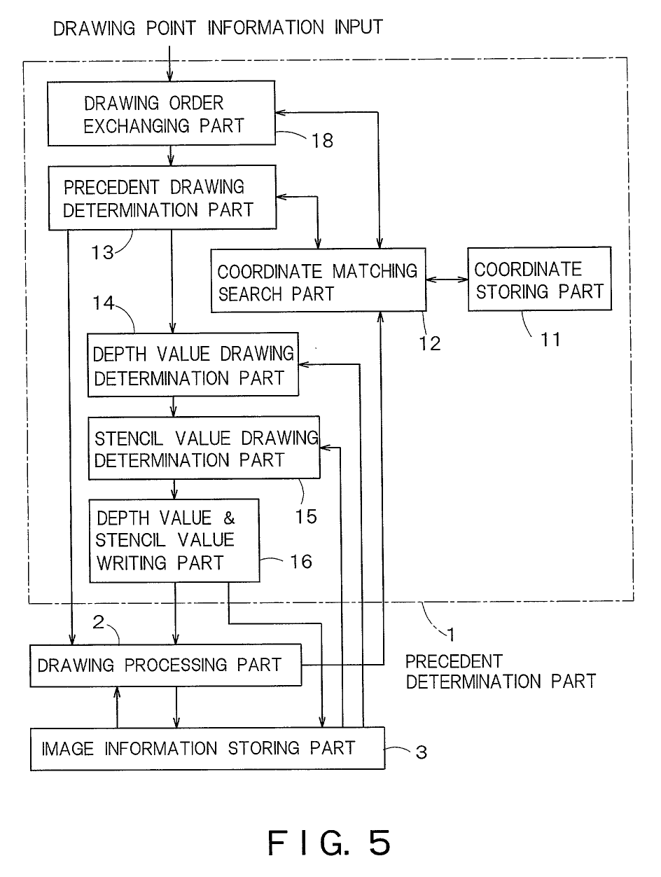

FIG. 5 is a block diagram of a third embodiment of an image drawing apparatus according to the present invention. In FIG. 5, the same figure numbers are attached to the constituents common to those of FIG. 5. Hereinafter, the different points will be mainly described.

The image drawing apparatus of FIG. 5 has a drawing order exchanging part 18, besides the configurations of FIG. 1. The drawing order exchanging part 18 performs the drawing processing of the other coordinate location by priority, prior to the drawing processing of the newly inputted coordinate location.

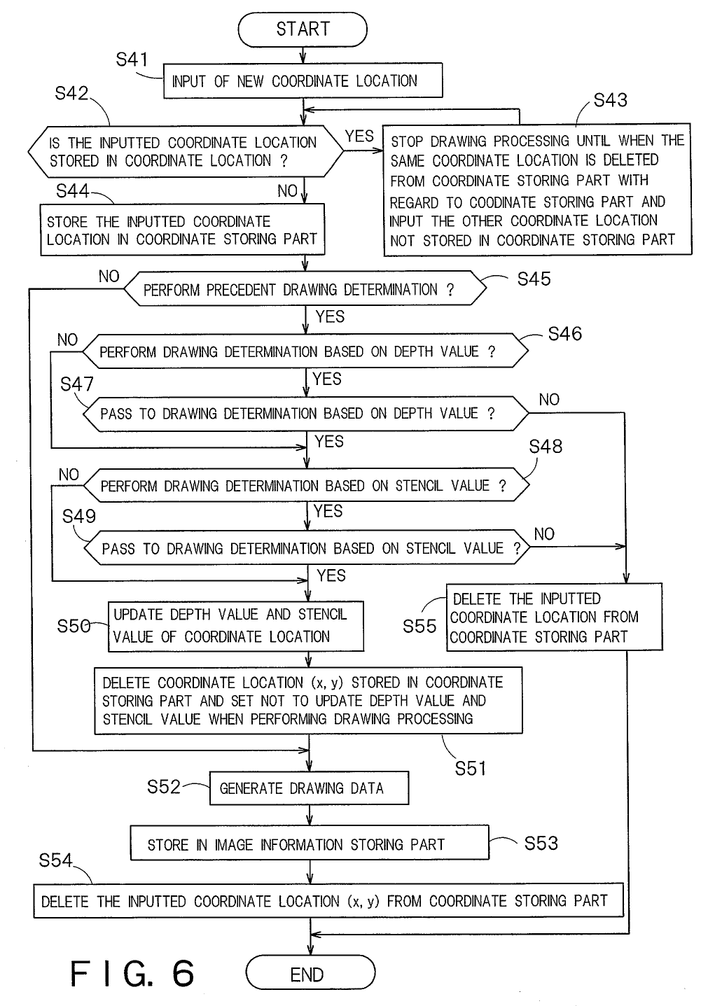

FIG. 6 is a flowchart showing processing procedure of the image drawing system of FIG. 5. After the new coordinate location (x, y) is inputted (step S41), it is determined whether or not the coordinate location is stored in the coordinate storing part 11 (step S42). When the coordinate location is stored in the coordinate storing part 11, the drawing processing of the coordinate location is stopped until the same coordinate location is deleted from the coordinate storing part 11, and the other coordinate location not to be stored in the coordinate storing part 11 is inputted (step S43).

When determined not to be stored in the coordinate storing part 1 in step S42, if the coordinate location is set to store the depth value or the stencil value, the coordinate location (x, y) is stored in the coordinate storing part 11 (step S44). Because the present embodiment stores the same coordinate location only once in the coordinate storing part 11, as the first and second embodiment, it is unnecessary to store the number of times inputting the same coordinate location in the coordinate storing part 11.

When the processing of step S44 is finished, the same processings as steps S3-S13 of FIG. 2 are performed.

Thus, because the third embodiment does not perform the overlapped drawing processing until the drawing processing of the coordinate location is finished, it is possible to perform consistent processings, even if data at the same coordinate location is continuously inputted.

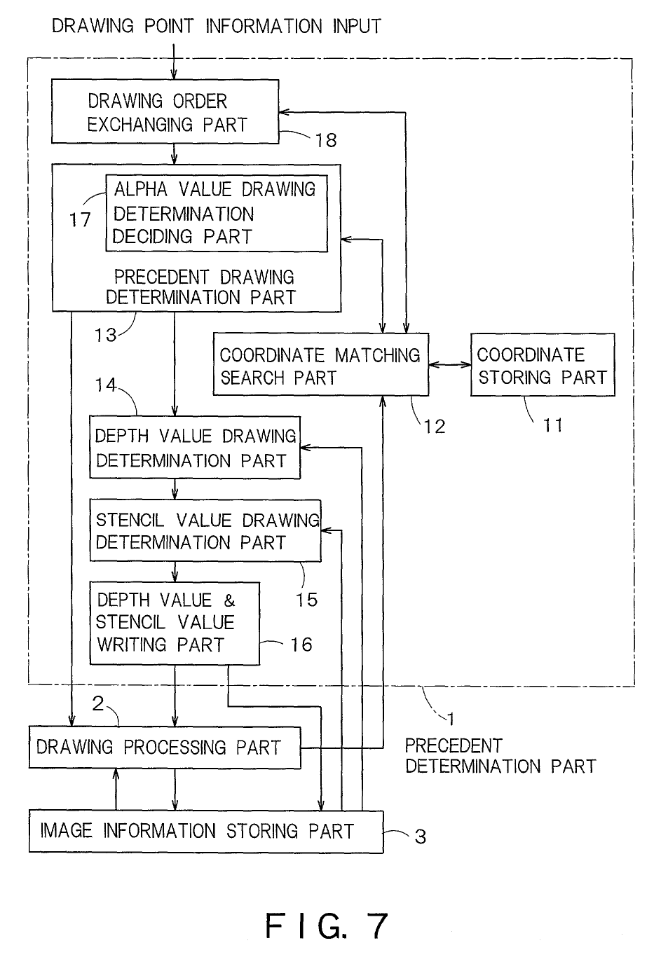

Although FIG. 5 has the drawing order exchanging part 18 added to the configurations of FIG. 1, the drawing order exchanging part 18 may be added to FIG. 3. The block configuration in this case is expressed as FIG. 7. The processing procedure of FIG. 7 is expressed in a flowchart adding steps S42 and S43 of FIG. 6 between steps S21 and S22 of FIG. 4.

The above-mentioned image drawing apparatus may be composed of hardware or software. In the case of being composed of software, the program for realizing the function of the image drawing apparatus may be contained in recording mediums such as a floppy disk or a CD-ROM, in order to be read out and execute by a computer. The recording medium is not limited to portable type of mediums such as magnetic disks or optical disks. The fixed type of mediums such as a hard disk drive or a semiconductor memory may be used.

The program for realizing the function of the above-mentioned image drawing apparatus may be delivered via communication lines including radio communication such as an internet. Furthermore, the program may be delivered at a state of encoding, modulating or compressing the program, via a fixed-line or radio-line such as the internet, or while containing the program in the recording medium.

What is claimed is:

1. An image drawing apparatus, comprising:
a coordinate storing part which stores coordinate locations of drawing points in which at least one of a depth value designating depth information of the drawing points and a stencil value designating mask information of the drawing point may be updated;
a precedent drawing determination part which performs at least one of a first drawing determination part configured to determine whether or not to perform drawing based the depth value stored in said coordinate storing part and a second drawing determination part configured to determine whether or not to perform drawing based the stencil value, for each coordinate location;
a drawing part which decides a color for each drawing point to perform drawing processing, and omits the drawing processing with regard to the coordinate location determined not to perform the drawing by said precedent drawing determination part.

2. The image drawing apparatus according to claim 1, further comprising:
a depth value update part which updates the depth value before the drawing processing by said drawing part with regard to the coordinate location determined to perform the drawing by said first drawing determination part.

3. The image drawing apparatus according to claim 1, further comprising:
a third drawing determination part which determines whether or not to perform the drawing based on an alpha value designating degree of transparency of the drawing point,
wherein at least one of said first and second drawing determination parts performs the drawing processings by said drawing part with regard to coordinate locations determined to perform the drawing by said third drawing determination part, and said drawing part omits the drawing processing with regard to coordinate locations determined not to perform the drawing by said third drawing determination part.

4. The image drawing apparatus according to claim 1, further comprising:
a coordinate delete part which deletes coordinate locations determined not to perform the drawing by said first drawing determination part, coordinate locations determined not to perform the drawing by said second drawing determination part, and coordinate locations where said drawing part has performed the drawing processing, from said coordinate storing part; and
a processing order setting part which performs drawing determination by a least one of said first and second drawing determination parts, and then performs the drawing processing by said drawing part, when the inputted coordinate location is not stored in said coordinate storing part.

5. The image drawing apparatus according to claim 4, wherein said processing order setting part performs the drawing determination by said first and second drawing determination part in the drawing processing by said drawing part with regard to the same coordinate location as that stored in said coordinate storing part.

6. The image drawing apparatus according to claim 4, wherein said processing order setting part performs the drawing determinations by said first and second drawing determination parts after the same coordinate location as that stored in said coordinate storing part is deleted from said coordinate storing part, and then performs the drawing processing by said drawing part based on the result of the drawing determinations.

7. An image drawing apparatus, comprising:
a coordinate storing part which stores coordinate locations of drawing points in which at least one of a depth value designating depth information of the drawing points and a stencil value designating mask information of the drawing point may be updated;
a first drawing determination part which determines whether or not to perform drawing based on the depth value for each coordinate location stored in said coordinate storing part;
a second drawing determination part which determines whether or not to perform drawing based on the stencil value for each coordinate location stored in said coordinate storing part; and
a drawing part which decides a color for each drawing point to perform drawing processing with regard to the coordinate location determined to perform the drawing by said first and second drawing determination parts, and omits said drawing processing with regard to the coordinate location determined not to perform the drawing by at least one of said first and second drawing determination parts.

8. The image drawing apparatus according to claim 7, further comprising:
a depth value updating part which updates the depth value before the drawing processing by said drawing part with regard to the coordinate location determined to perform drawing by said first drawing determination part.

9. The image drawing apparatus according to claim 7, further comprising:
a third drawing determination part which determines whether or not to perform the drawing based on an alpha value designating degree of transparency of the drawing point,
wherein at least one of said first and second drawing determination parts performs the drawing processings by said drawing part with regard to coordinate locations determined to perform the drawing by said third drawing determination part, and said drawing part omits the drawing processing with regard to coordinate locations determined not to perform the drawing by said third drawing determination part.

10. The image drawing apparatus according to claim 7, further comprising:
a coordinate delete part which deletes coordinate locations determined not to perform the drawing by said first drawing determination part, coordinate locations determined not to perform the drawing by said second drawing determination part, and coordinate locations where said drawing part has performed the drawing processing, from said coordinate storing part; and
a processing order setting part which performs drawing determination by a least one of said first and second drawing determination parts, and then performs the drawing processing by said drawing part, when the inputted coordinate location is not stored in said coordinate storing part.

11. The image drawing apparatus according to claim 10, wherein said processing order setting part performs the drawing determination by said first and second drawing determination part in the drawing processing by said drawing part with regard to the same coordinate location as that stored in said coordinate storing part.

12. The image drawing apparatus according to claim 10, wherein said processing order setting part performs the drawing determinations by said first and second drawing determination parts after the same coordinate location as that stored in said coordinate storing part is deleted from said coordinate storing part, and then performs the drawing processing by said drawing part based on the result of the drawing determinations.

13. An image drawing apparatus, comprising:
a coordinate storing part which stores coordinate locations of drawing points in which at least one of a depth value designating depth information of the drawing points and a stencil value designating mask information of the drawing points may be updated;
a first drawing determination part which determines whether or not to perform drawing based on the depth value stored in said coordinate storing part for each coordinate location stored in said coordinate storing part;
a second drawing determination part which determines whether or not to perform drawing based on the stencil value for each coordinate location stored in said coordinate storing part;
a third drawing determination part which determines whether or not to perform drawing based on an alpha value designating degree of transparency of the drawing points; and
a drawing part which if determined to perform the drawing by said third drawing determination part, after performing the processings by said first and second drawing determination parts, decides a color for each drawing point to perform drawing processing, and omits the drawing processing with regard to the coordinate location determined not to perform the drawing by said third drawing determination part.

14. The image drawing apparatus according to claim 13, further comprising:
a depth value update part which updates the depth value before the drawing processing by said drawing part with regard to the coordinate location determined to perform the drawing by said first drawing determination part.

15. The image drawing apparatus according to claim 13, further comprising:
a coordinate delete part which deletes coordinate locations determined not to perform the drawing by said first drawing determination part, coordinate locations determined not to perform the drawing by said second drawing determination part, and coordinate locations where said drawing part has performed the drawing processing, from said coordinate storing part; and
a processing order setting part which performs drawing determination by a least one of said first and second drawing determination parts, and then performs the drawing processing by said drawing part, when the inputted coordinate location is not stored in said coordinate storing part.

16. The image drawing apparatus according to claim 14, wherein said processing order setting part performs the drawing determination by said first and second drawing determination part in the drawing processing by said drawing part with regard to the same coordinate location as that stored in said coordinate storing part.

17. The image drawing apparatus according to claim 14, wherein said processing order setting part performs the drawing determinations by said first and second drawing determination parts after the same coordinate location as that stored in said coordinate storing part is deleted from said coordinate storing part, and then performs the drawing processing by said drawing part based on the result of the drawing determinations.

18. An image drawing method, comprising:
storing coordinate locations of drawing points in which at least one of a depth value designating depth information of the drawing points and a stencil value designating mask information of the drawing point may be updated;
performing at least one of a determination whether or not to perform drawing based on the depth value and a determination whether or not to perform drawing based on the stencil value, for each of the stored coordinate locations; and
deciding color for each drawing point to perform the drawing with regard to the coordinate locations determined to perform the drawing, and omitting the drawing processing with regard to the coordinate locations determined not to perform the drawing.

19. An image drawing method, comprising:
storing coordinate locations of drawing points in which at least one of a depth value designating depth information of the drawing points and a stencil value designating mask information of the drawing point may be updated;
determining whether or not to perform drawing based on the depth value for each of the stored coordinate locations;
determining whether or not to perform drawing based on the stencil value for each coordinate location stored in said coordinate storing part; and
deciding a color for each drawing point to perform drawing processing with regard to the coordinate locations determined to perform the drawing based on said depth value and determined to perform the drawing based on said stencil value, and omitting the drawing processing with regard to the coordinate locations determined not to perform the drawing.

20. An image drawing method, comprising:
storing coordinate locations of drawing points in which at least one of a depth value designating depth information of the drawing points and a stencil value designating mask information of the drawing points may be updated;
determining whether or not to perform drawing based on the depth value stored in said coordinate storing part for each coordinate location stored in said coordinate storing part;
determining whether or not to perform drawing based on the stencil value for each coordinate location stored in said coordinate storing part;
determining whether or not to perform drawing based on an alpha value designating degree of transparency of the drawing points; and
if determined to perform the drawing by said third drawing determination part, after performing the determination whether or not to perform the drawing based on said depth value and the determination whether or not to perform the drawing based on said stencil value, deciding a color for each drawing point to perform drawing processing, and omitting the drawing processing with regard to the coordinate locations determined not to perform drawing based on said alpha value.
